(19) United States
(12) Patent Application Publication
(10) Pub. No.: US 2015/0112495 A1
(43) Pub. Date: Apr. 23, 2015

(54) APPARATUS AND METHOD FOR EXTRACTING MAXIMUM POWER FROM ENERGY HARVESTER APPARATUS

(71) Applicant: Electronics and Telecommunications Research Institute, Daejeon (KR)

(72) Inventors: Sung-Eun KIM, Daejeon (KR); Tae-Wook KANG, Daejeon (KR); Sung-Weon KANG, Daejeon (KR); Kyung-Hwan PARK, Daejeon (KR)

(21) Appl. No.: 14/502,305

(22) Filed: Sep. 30, 2014

(30) Foreign Application Priority Data
Oct. 22, 2013 (KR) 10-2013-0125953
May 15, 2014 (KR) 10-2014-0058256

(51) Int. Cl. G05F 1/67; G05B 15/02

(52) U.S. Cl. CPC G05F 1/67; G05B 15/02
USPC 700/287

(57) ABSTRACT

An apparatus and a method capable of maximally transferring energy generated from an energy harvester apparatus to an output terminal by optimizing an input impedance of an apparatus for extracting maximum power disposed between an energy harvester apparatus and an energy storage apparatus are disclosed. The method for extracting maximum power includes: detecting, by an apparatus for extracting maximum power disposed between the energy harvest apparatus and an energy storage apparatus, a magnitude in output current flowing in the energy storage apparatus; comparing a magnitude in current extracted from the energy harvester apparatus with a magnitude in current supplied to the energy storage apparatus when the magnitude in output current is a positive number; and determining whether an algorithm for extracting maximum power using the magnitude in current based on the comparison result is applied and extracting the maximum power depending on the determination result.

### CROSS REFERENCE TO RELATED APPLICATION

This application claims the benefit of Korean Patent Application Nos. 10-2013-0125953 and 10-2014-0058256, filed on Oct. 22, 2013 and May 15, 2014, respectively, which are hereby incorporated by reference in its entirety into this application.

### BACKGROUND OF THE INVENTION

1. Technical Field

The present invention relates to an apparatus and a method for extracting maximum power from an energy harvester apparatus, and more particularly, to an apparatus and a method capable of maximally transferring energy generated from an energy harvester apparatus to an output terminal by optimizing an input impedance of a an apparatus for extracting maximum power disposed between an energy harvester apparatus and an energy storage apparatus.

2. Description of the Related Art

An energy source has a different magnitude in energy which may be transferred due to impedance of a latter stage thereof. To solve the above problem, a maximum power point tracking technology has been continuously developed.

An MPPT technology has used methods such as open voltage (OV), perturb and observe (P&O), and incremental conductance (IC). These methods are to measure a magnitude in voltage or current at an MPPT input terminal using an analog-digital converter (ADC), calculate a magnitude in energy based on the measured magnitude in voltage or current, and then find out a condition to give a maximum magnitude in energy based on a Hill-climbing algorithm.

The simplest constant voltage method (CV) among the MPPT technologies includes setting, by a photovoltaic (PV) system, to a voltage of maximum power to be a reference voltage and controlling a duty-cycle of a DC-DC converter so that a voltage connected to the PV becomes a reference voltage. To this end, the constant voltage method needs to measure a magnitude in an operating voltage of the PV. For example, Korean Patent Laid-Open Publication No. 2010-0132696 entitled “Apparatus And Method For Controlling POS MPPT In Solar Power Generation System” discloses a technology of providing maximum power at a maximum speed and stably by controlling a duty ratio based on a comparison of a previous current with a present current which are output from a DC-DC converter.

A short current pulse method (SC) is a method for obtaining an operating current receiving maximum power based on a magnitude in short current. A relationship between the magnitude in short current and the operating current has a constant proportion relationship. To this end, there is a need to measure the magnitude in short current. Power is not supplied during the measurement of short current and a voltage needs to be measured to obtain the reference voltage capable of generating an operating current.

The open voltage method (OV) is a method for utilizing a fact that an open voltage and a voltage of maximum power are set at a predetermined ratio. Generally, a voltage corresponding to 76% of the open voltage becomes a voltage which may supply maximum power. To implement the above algorithm, a magnitude in the open voltage is measured and an operating voltage of the PV is measured and thus is induced to be 76% of the open voltage. Further, similar to the short current pulse method (SC), power is not supplied during the measurement of the open voltage.

The perturb and observe method (P & O) adopts a method for periodically observing a voltage and a current and comparing a voltage with a current observed in a previous step. When the operating voltage is changed and the magnitude in power is increased, an operating point is continued in the same direction and when the magnitude in power is reduced, the operating point moves in an opposite direction thereto. In the case of the P & O method, the voltage needs to be observed for every MPPT period, and even when the power reaches a maximum power point according to the voltage, it may be appreciated based on the continuous observation that a value of output power is oscillated in the vicinity of a maximum value. This causes power consumption. In particular, when environment is suddenly changed, a voltage may be changed to a wrong direction.

The incremental conductance (IncCond) method is a method for comparing conductance of output from a solar cell with incremental conductance to extract a maximum power operating point. In the case of utilizing the method, at the time of reaching the maximum power operating point, the incremental conductance method stops a process of extracting the maximum power operating point and performs an operation of relatively rapidly coping with the environment.

However, even though receiving large power from a harvester module based on the MPPT technology, when efficiency of a module performing the MPPT function is not considered, the magnitude in power transferred to the final output side may be rather reduced. For example, even though power of 100 mW is extracted by performing the MPPT function in the harvester module, in the case of the MPPT module adopting the DC-DC converter structure, the efficiency is changed depending on input and output conditions. Even in the case of receiving the power of 100 mW as the input, when the efficiency of the MPPT module itself is 50%, the magnitude in power which may be transferred to a final output terminal is only 50 mW. On the other hand, even though the harvester module generates a power of 70 mW, when the MPPT module is driven at the efficiency of 90%, a power of 63 mW may be transferred to an output terminal.

There is a need to check and maximize a magnitude in current flowing in the energy storage apparatus in consideration of the efficiency of the MPPT module.

### SUMMARY OF THE INVENTION

Accordingly, the present invention has been made keeping in mind the above problems occurring in the conventional art, and an object of the present invention is to provide a method for maximally transferring energy generated from an energy harvester apparatus to an output terminal by optimizing an input impedance of an apparatus for extracting maximum power disposed between the energy harvester apparatus and the energy storage apparatus.

In accordance with an aspect of the present invention, there is provided a method for extracting maximum power from an energy harvester apparatus, the method including: detecting, by an apparatus for extracting maximum power disposed between the energy harvest apparatus and an energy storage apparatus, a magnitude in output current flowing in the energy storage apparatus; comparing a magnitude in current extracted from the energy harvester apparatus with a magnitude in current supplied to the energy storage apparatus when the magnitude in output current is a positive number; and determining whether an algorithm for extracting maximum power using the magnitude in current based on the comparison result is applied and extracting the maximum power depending on the determination result.

The method may further include: when the magnitude in output current detected in the detecting of the magnitude in output current is a negative number or 0, performing, by the apparatus for extracting maximum power, a control to disconnect the energy storage apparatus.

In the extracting of the maximum power, when the magnitude in current supplied to the energy storage apparatus is larger than the magnitude in current extracted from the energy harvester apparatus, the maximum power may be extracted by applying the algorithm for extracting maximum power based on the magnitude in output current.

In the extracting of the maximum energy, when the magnitude in current supplied to the energy storage apparatus is smaller than the magnitude in the current extracted from the energy harvester apparatus, the algorithm for extracting maximum power based on the magnitude in output current may not be applied.

In the detecting of the magnitude in output current flowing in the energy storage apparatus, the magnitude in output current may be detected by differentiating a variation of charging voltage of the energy storage apparatus.

In accordance with another aspect of the present invention, there is provided an apparatus for extracting maximum power from an energy harvester apparatus, the apparatus including: a current detection unit detecting a magnitude in output current supplied to an energy storage apparatus; a comparison unit comparing a magnitude in current extracted from the energy harvester apparatus with a magnitude in current supplied to the energy storage apparatus when the magnitude in output current is a positive number; and a control unit determining whether an algorithm for extracting maximum power using the magnitude in current based on the comparison result is applied and extracting the maximum power depending on the determination result.

The control unit may perform a control to disconnect the energy storage apparatus when the magnitude in output current is a negative number or 0.

The control unit may extract the maximum power by applying the algorithm for extracting maximum power based on the magnitude in output current when the magnitude in current supplied to the energy storage apparatus is larger than the magnitude in current extracted from the energy harvester apparatus.

The control unit may not apply the algorithm for extracting maximum power based on the magnitude in output current when the magnitude in current supplied to the energy storage apparatus is smaller than the magnitude in the current extracted from the energy harvester apparatus.

In accordance with still another aspect of the present invention, there is provided an apparatus for extracting maximum power from an energy harvester apparatus to extract maximum power between the energy harvester apparatus and an energy storage apparatus, the apparatus including: a differential unit detecting a magnitude in current based on a variation of charging voltage of the energy storage apparatus; a comparison unit comparing a magnitude in current extracted from the energy harvester apparatus with a magnitude in current supplied to the energy storage apparatus when the magnitude in current is a positive number; and a control unit performing a control to determine whether an algorithm for extracting maximum power using the magnitude in current based on the comparison result is applied and extract the maximum power depending on the determination result.

The control unit may perform a control to disconnect the energy storage apparatus when the magnitude in current is a negative number or 0.

The control unit may extract the maximum power by applying the algorithm for extracting maximum power based on the magnitude in current when the magnitude in current supplied to the energy storage apparatus is larger than the magnitude in current extracted from the energy harvester apparatus.

The control unit may not apply the algorithm for extracting maximum power based on the magnitude in current when the magnitude in current supplied to the energy storage apparatus is smaller than the magnitude in the current extracted from the energy harvester apparatus.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating a structure between an energy harvester apparatus and an energy storage apparatus;

FIG. 2 is a diagram illustrating environment which is applied to an apparatus for extracting maximum power according to an exemplary embodiment of the present invention;

FIG. 3 is a configuration diagram schematically illustrating the apparatus for extracting maximum power according to the exemplary embodiment of the present invention;

FIG. 4 is a diagram illustrating environment which is applied to an apparatus for extracting maximum power according to another exemplary embodiment of the present invention;

FIG. 5 is a configuration diagram schematically illustrating the apparatus for extracting maximum power according to another exemplary embodiment of the present invention;

FIG. 6 is a flow chart illustrating a method for extracting maximum power according to an exemplary embodiment of the present invention; and

FIG. 7 is a graph illustrating an output changed in response to a maximum operating frequency of the apparatus for extracting maximum power according to the exemplary embodiment of the present invention.

### DESCRIPTION OF THE PREFERRED EMBODIMENTS

Embodiments of the present invention will be described in detail with reference to the accompanying drawings. In the present specification, an overlapped description and a detailed description for well-known functions and configurations that may obscure the gist of the present invention will be omitted. Preferred embodiments of the present invention are provided in order to more completely explain the present invention to those skilled in the art. Therefore, throughout the accompanying drawings, shapes, sizes, and the like, of components may be exaggerated for clarity.

Hereinafter, an apparatus and a method for extracting maximum power capable of maximally transferring energy generated from an energy harvester apparatus to an output terminal by optimizing an input impedance of the apparatus for extracting maximum power disposed between the energy harvester apparatus and an energy storage apparatus according to an exemplary embodiment of the present invention will be described with reference to the accompanying drawings.

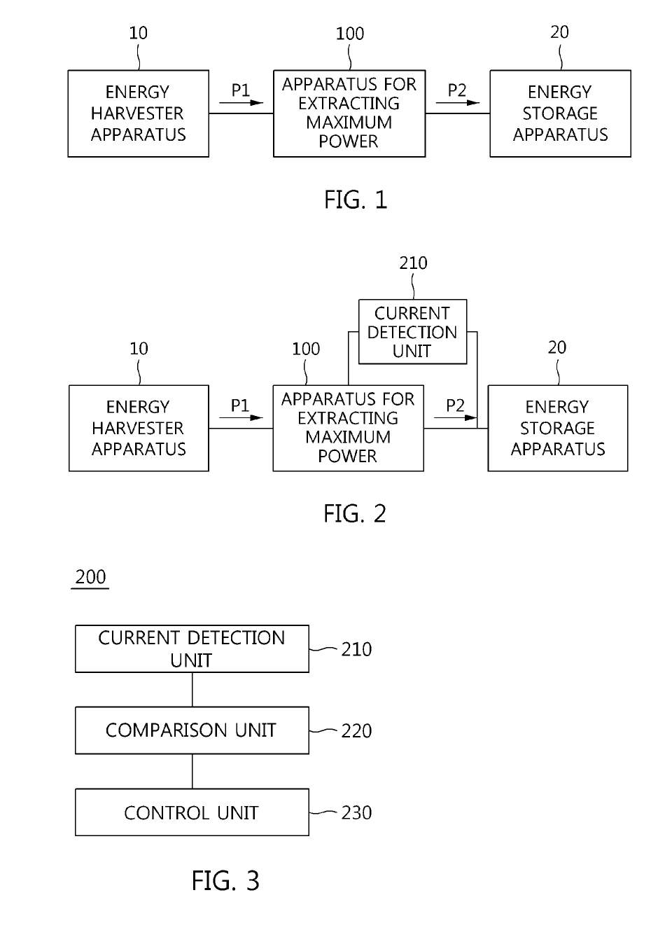

FIG. 1 is a diagram illustrating a structure between an energy harvester apparatus and an energy storage apparatus.

Referring to FIG. 1, a module which is applied to an apparatus 100 for extracting maximum power, that is, a maximum power point tracking technology is disposed between an energy harvester apparatus 10 and an energy storage apparatus 20.

The energy harvester apparatus 10 generates energy.

The apparatus 100 for extracting maximum power extracts maximum energy (hereinafter, referred to as (hereinafter, referred to as “maximum power”) from the energy harvester apparatus 10).

The energy storage apparatus 20 stores power extracted from the apparatus 100 for extracting maximum power.

In the structure illustrated in FIG. 1, in the case of utilizing the existing method, the apparatus 100 for extracting maximum power aims to detect a magnitude in energy generated from the energy harvester apparatus and extract maximum power from the energy harvester apparatus 10.

However, the apparatus 100 for extracting maximum power is generally implemented as a DC-DC converter, which has different efficiencies depending on input and output conditions.

Therefore, the existing apparatus 100 for extracting maximum power may not transfer maximum power to the energy storage apparatus 20 only by extracting the maximum power from the energy harvester apparatus 10. To this end, a structure to transfer the maximum power to the energy storage apparatus 20 by applying efficiency of the apparatus 100 for extracting maximum energy itself needs to be adopted.

Next, to this end, the environment and configuration of an apparatus 200 for extracting maximum power according to an exemplary embodiment of the present invention will be described with reference to FIGS. 2 and 3.

FIG. 2 is a diagram illustrating environment which is applied to the apparatus for extracting maximum power according to the exemplary embodiment of the present invention and FIG. 3 is a configuration diagram schematically illustrating the apparatus for extracting maximum power according to the exemplary embodiment of the present invention.

Referring to FIG. 2, the apparatus 200 for extracting maximum power according to the exemplary embodiment of the present invention, that is, a module to which a maximum power point tracking (MPPT) technology is applied is disposed between the energy harvester apparatus 10 and the energy storage apparatus 20.

Referring to FIG. 3, the apparatus 200 for extracting maximum power includes a current detection unit 210, a comparison unit 220, and a control unit 230.

The current detection unit 210 is disposed at an output terminal of the apparatus for extracting maximum power to detect a magnitude in current flowing in the energy storage apparatus 20. This may confirm how much a current flows in the energy storage apparatus 20 under given conditions of the energy storage apparatus 20. The maximum power may not be transferred to the energy storage apparatus 20 only by maximizing the magnitude in power extracted from the energy harvester apparatus 10. This may be made based on operating efficiency of the apparatus 200 for extracting maximum power itself and a state in the energy storage apparatus 20, and therefore there is a need to detect the magnitude in current flowing in the energy storage apparatus 20 from the apparatus for extracting maximum power.

The comparison unit 220 confirms whether the magnitude in current detected by the current detection unit 210 keeps a positive number (+) and compares the magnitude in current with a previously measured magnitude in current.

The control unit 230 controls the magnitude in current detected by the current detection unit 210 to be kept at the positive number (+) and when the magnitude in current is changed to a negative number (−) or 0, performs a control to disconnect the energy storage apparatus 20 to prevent a reverse current from flowing from the energy storage apparatus 20.

The control unit 230 detects the magnitude in current flowing in the energy storage apparatus 20 from the output terminal of the apparatus for extracting maximum power when the magnitude in current is larger than the previously measured current to perform a control to apply a new algorithm for extracting maximum energy. On the other hand, the control unit 230 performs a control so as not to apply the new algorithm when the magnitude in current is smaller than that of the previously measured current.

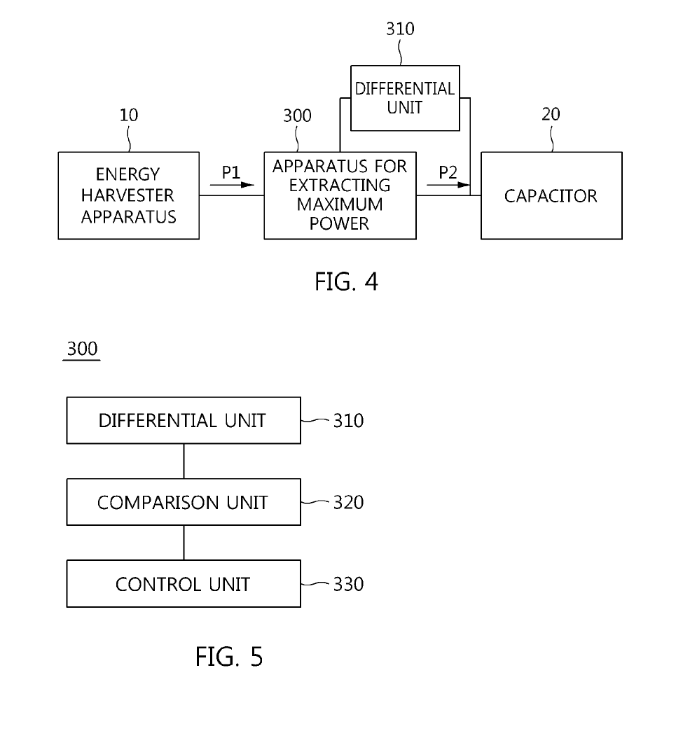

Next, the environment and configuration of the apparatus 300 for extracting maximum power which are applied when a capacitor or a battery is used as the energy storage apparatus 20 will be described in detail with reference to FIGS. 4 and 5.

FIG. 4 is a diagram illustrating environment which is applied to an apparatus for extracting maximum power according to another exemplary embodiment of the present invention and FIG. 5 is a configuration diagram schematically illustrating the apparatus for extracting maximum power according to another exemplary embodiment of the present invention.

The energy storage apparatus 20 according to another exemplary embodiment of the present invention utilizes a capacitor or a battery to store energy.

In FIG. 4, maximum energy extracted from an apparatus 300 for extracting maximum power using the capacitor is stored but the exemplary embodiment of the present invention is not limited thereto.

Referring to FIG. 5, the apparatus 300 for extracting maximum energy includes a differential unit 310, a comparison unit 320, and a control unit 330.

The differential unit 310 differentiates a variation (dv/dt) of a charging voltage of the capacitor 20 to detect a magnitude in current based on the following Equation 1.

I=C(dV/dt) [Equation 1]

The comparison unit 20 confirms a differential result of the differential unit 310, which is, the magnitude in current and then determines whether to increase energy stored in the energy storage apparatus 20.

Although the magnitude in energy generated from the energy harvester apparatus 10, that is, the magnitude in power is increased, when the magnitude in power charged in the capacitor 20 is not increased but reduced, the control unit 330 performs a control so as not to apply an algorithm using the differential unit 310.

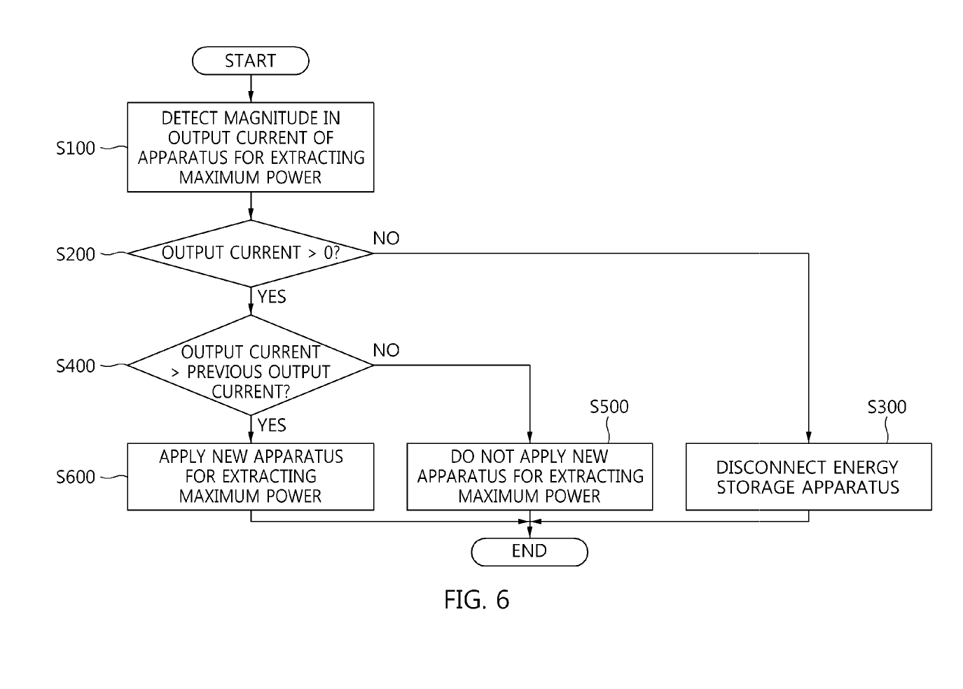

Next, the method for extracting maximum power will be described in detail with reference to FIG. 6.

FIG. 6 is a flow chart illustrating a method for extracting maximum power according to an exemplary embodiment of the present invention.

First, the apparatus 200 for extracting maximum power according to the exemplary embodiment of the present invention, that is, a module to which a maximum power point tracking (MPPT) technology is applied is disposed between the energy harvester apparatus 10 and the energy storage apparatus 20.

Referring to FIG. 6, the apparatus 200 for extracting maximum power detects its own output current, that is, a magnitude in current flowing in the energy storage apparatus 20 (S100).

The apparatus 200 for extracting maximum power confirms whether the magnitude in current detected in S100 is larger than 0.

The apparatus 200 for extracting maximum power performs a control to disconnect the energy storage apparatus 20 when the magnitude in current detected in S100 is converted into a negative number (−) or 0 to prevent a reverse current from flowing from the energy storage apparatus 20.

The apparatus 200 for extracting maximum power compares the magnitude in current detected in S100 with the previously measured magnitude in current when the magnitude in current detected in S100 keeps a positive number (+) (S400). Herein, the previously measured magnitude in current corresponds to the magnitude in current extracted from the energy harvester apparatus 10.

When the magnitude in current extracted from the energy harvest apparatus 10 is increased but the magnitude in current supplied to the energy storage apparatus 20 is not increased, the apparatus 200 for extracting maximum power performs a control so as not to apply a new algorithm (S500). Herein, the new algorithm corresponds to an algorithm extracting maximum energy based on the magnitude in current supplied to the energy storage apparatus 20.

Only when the magnitude in current extracted from the energy harvest apparatus 10 and the magnitude in current supplied to the energy storage apparatus 20 is increased, the apparatus 200 for extracting maximum power performs a control to apply the new algorithm (S600) so as to be able to transfer the maximum power generated from the energy harvest apparatus 10 to the energy storage apparatus 20.

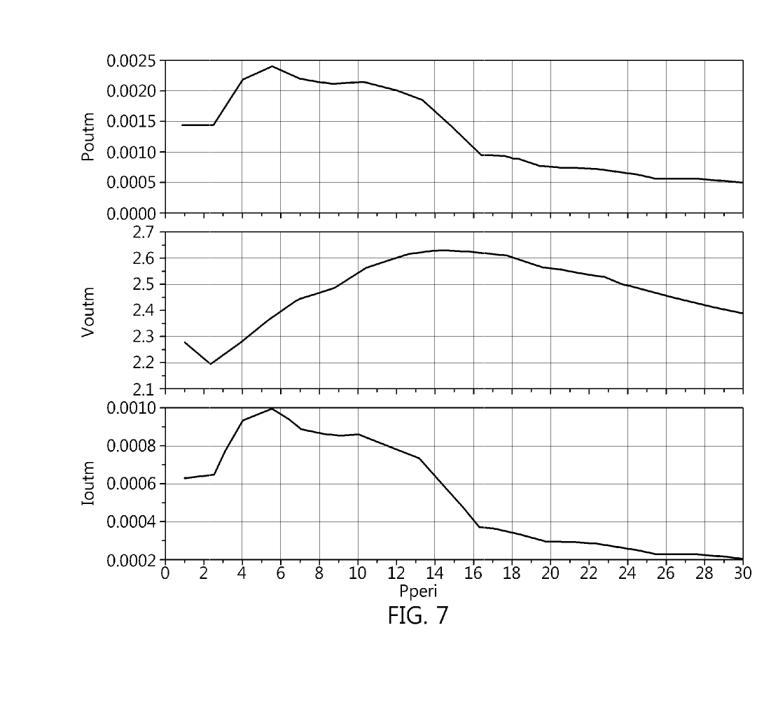

Next, an output changed in response to an operating frequency of the apparatus for extracting maximum power will be described in detail with reference to FIG. 7.

FIG. 7 is a graph illustrating an output changed in response to a maximum operating frequency of the apparatus for extracting maximum power according to the exemplary embodiment of the present invention.

FIG. 7 illustrates that a magnitude in output power Poutm of the apparatus for extracting maximum power is changed in response to the operating frequency of the apparatus for extracting maximum power and a magnitude in output voltage Voutm and output current Ioutm of the apparatus for extracting maximum power is changed in response to the operating frequency of the apparatus for extracting maximum power.

First, a load condition of the graph of FIG. 7 is a capacitor of 1 μF and a resistor of 4K ohm.

It may be confirmed based on the graph of FIG. 7 that the magnitude in output power of the apparatus for extracting maximum power is substantially similar to the variation of output current.

As a result, the maximum power may be supplied to the energy storage apparatus by confirming only the output current in the case of the apparatus for extracting maximum power according to the exemplary embodiment of the present invention. Unlike the method for confirming voltage and current by the apparatus for extracting maximum power and calculating power based on the confirmation result according to the related art, it can be appreciated that according to the exemplary embodiment of the present invention, power may be maximized only by confirming the output current.

According to the exemplary embodiments of the present invention, it is possible to apply the conversion efficiency of the apparatus for extracting maximum power to the MPPT function by adopting the method for maximizing the magnitude in energy transferred by confirming the magnitude in current flowing in the energy storage apparatus from the apparatus for extracting maximum power. This is to store the energy generated from the energy harvester apparatus in the energy storage apparatus at the latter stage of the apparatus for extracting maximum power. By this, the maximum energy from the energy harvester apparatus may be stored in the energy storage apparatuses such as a battery and a capacitor.

The optimal exemplary embodiments are disclosed above in the drawings and the specification. Herein, specific terms have been used, but are just used for the purpose of describing the present invention and are not used for qualifying the meaning or limiting the scope of the present invention, which is disclosed in the appended claims. Therefore, it will be appreciated to those skilled in the art that various modifications are made and other equivalent embodiments are available. Accordingly, the actual technical protection scope of the present invention must be determined by the spirit of the appended claims.

What is claimed is:

1. A method for extracting maximum power from an energy harvester apparatus, the method comprising:
detecting, by an apparatus for extracting maximum power disposed between the energy harvest apparatus and an energy storage apparatus, a magnitude in output current flowing in the energy storage apparatus;
comparing a magnitude in current extracted from the energy harvester apparatus with a magnitude in current supplied to the energy storage apparatus when the magnitude in output current is a positive number; and
determining whether an algorithm for extracting maximum power using the magnitude in current based on the comparison result is applied and extracting the maximum power depending on the determination result.

2. The method of claim 1, further comprising:
when the magnitude in output current detected in the detecting of the magnitude in output current is a negative number or 0, performing, by the apparatus for extracting maximum power, a control to disconnect the energy storage apparatus.

3. The method of claim 1, wherein in the extracting of the maximum power, when the magnitude in current supplied to the energy storage apparatus is larger than the magnitude in current extracted from the energy harvester apparatus, the maximum power is extracted by applying the algorithm for extracting maximum power based on the magnitude in output current.

4. The method of claim 1, wherein in the extracting of the maximum energy, when the magnitude in current supplied to the energy storage apparatus is smaller than the magnitude in the current extracted from the energy harvester apparatus, the algorithm for extracting maximum power based on the magnitude in output current is not applied.

5. The method of claim 1, wherein in the detecting of the magnitude in output current flowing in the energy storage apparatus, the magnitude in output current is detected by differentiating a variation of charging voltage of the energy storage apparatus.

6. An apparatus for extracting maximum power from an energy harvester apparatus, the apparatus comprising:
a current detection unit detecting a magnitude in output current supplied to an energy storage apparatus;
a comparison unit comparing a magnitude in current extracted from the energy harvester apparatus with a magnitude in current supplied to the energy storage apparatus when the magnitude in output current is a positive number; and
a control unit determining whether an algorithm for extracting maximum power using the magnitude in current based on the comparison result is applied and extracting the maximum power depending on the determination result.

7. The apparatus of claim 6, wherein the control unit performs a control to disconnect the energy storage apparatus when the magnitude in output current is a negative number or 0.

8. The apparatus of claim 6, wherein the control unit extracts the maximum power by applying the algorithm for extracting maximum power based on the magnitude in output current when the magnitude in current supplied to the energy storage apparatus is larger than the magnitude in current extracted from the energy harvester apparatus.

9. The apparatus of claim 6, wherein the control unit does not apply the algorithm for extracting maximum power based on the magnitude in output current when the magnitude in current supplied to the energy storage apparatus is smaller than the magnitude in the current extracted from the energy harvester apparatus.

10. An apparatus for extracting maximum power from an energy harvester apparatus to extract maximum power between the energy harvester apparatus and an energy storage apparatus, the apparatus comprising:
a differential unit detecting a magnitude in current based on a variation of charging voltage of the energy storage apparatus;
a comparison unit comparing a magnitude in current extracted from the energy harvester apparatus with a magnitude in current supplied to the energy storage apparatus when the magnitude in current is a positive number; and
a control unit performing a control to determine whether an algorithm for extracting maximum power using the magnitude in current based on the comparison result is applied and extract the maximum power depending on the determination result

11. The apparatus of claim 10, wherein the control unit performs a control to disconnect the energy storage apparatus when the magnitude in current is a negative number or 0.

12. The apparatus of claim 10, wherein the control unit extracts the maximum power by applying the algorithm for extracting maximum power based on the magnitude in current when the magnitude in current supplied to the energy storage apparatus is larger than the magnitude in current extracted from the energy harvester apparatus.

13. The apparatus of claim 10, wherein the control unit does not apply the algorithm for extracting maximum power based on the magnitude in current when the magnitude in current supplied to the energy storage apparatus is smaller than the magnitude in the current extracted from the energy harvester apparatus.
